(19) United States
(12) Patent Application Publication
(10) Pub. No.: US 2007/0229956 A1
(43) Pub. Date: Oct. 4, 2007

(54) LIGHT REFLECTIVE SHEET

(75) Inventors: HIDESHI SAKAMOTO, Ichihara-shi (JP); MINORU TOYAMA, Ichihara-shi (JP); YUJI ANDO, Ichihara-shi (JP); TAKAHIRO HATTORI, Ichihara-shi (JP)

Correspondence Address: J C PATENTS, INC., 4 VENTURE, SUITE 250, IRVINE, CA, 92618, US

(73) Assignees: CHISSO CORPORATION, OSAKA (JP); CHISSO PETROCHEMICAL CORPORATION, TOKYO (JP)

(21) Appl. No.: 11/692,633

(22) Filed: Mar. 28, 2007

(30) Foreign Application Priority Data
Mar. 30, 2006 (JP) 2006-94295
Mar. 19, 2007 (JP) 2007-69886

(51) Int. Cl. G02B 1/10

(52) U.S. Cl. 359/580

(57) ABSTRACT

Object: To provide a rigid light reflective sheet with excellent light reflecting characteristics, ultraviolet yellowing resistance and dimensional stability.

Means to solve: A light reflective sheet wherein the void containing light reflective layer (B) is laid on the light receiving side of a substrate layer (A) composed of a thermoplastic resin composition (a1) containing an inert particle of 5 to 40% in weight, the backing layer (C) is laid on the non-light receiving side of the substrate layer (A), and the void containing light reflective layer (B) is a uniaxially or biaxially stretched sheet with a thickness (tb) of 10 to 90 μm and diffuse reflectance of 70 to 90%.

### CROSS-REFERENCE TO RELATED APPLICATION

This application claims the priority benefit of Japanese application serial no. 2006-94295, filed Mar. 30, 2006 and serial no. 2007-69886 filed Mar. 19, 2007. All disclosures of the Japanese applications are incorporated herein by reference.

### TECHNICAL FIELD

The present invention relates to a light reflective sheet. The invention specifically relates to the light reflective sheet suitably used in the backlight of liquid crystal display and an electric spectacular board, particularly in a large size liquid crystal display, and a light reflective sheet with few changes over time, for a long period of time, under the irradiation of ultraviolet light from a light source, having excellent dimensional stability and rigidity.

Additionally, in the present invention, sheet is the generic term for sheet and film. Also, in a light reflective sheet, the side which receives light from a light source is referred to as “light receiving face”, and the reverse side of the light receiving face, which does not receive light from a light source, is referred to as “non-light receiving face.”

### BACKGROUND ART

A light reflective sheet is generally composed of a metal sheet such as aluminum and stainless sheet, a deposited sheet that aluminum or silver is evaporated/deposited on PET sheet, or a laminate laminated with an aluminum metal foil. It is also composed of a void containing sheet in which a hole (hereinafter referred to as void) is formed in a thermoplastic resin sheet, and is used in the backlight of a liquid crystal display and an electric spectacular board. Particularly in recent years, it is widely used as a major part of the backlight used in liquid crystal displays of word processors, personal computers and televisions.

For the backlights of a liquid crystal display, there is the edge light method where light sources are disposed on the sides of a transparent optical waveguide, and the bottom emitting method where light sources are directly disposed on the backside of the liquid crystal part. For a small or medium size liquid crystal display such as cellular phones and lap top computers, the edge light method is used to create thinner models, whereas for a large size liquid crystal display like a large television, the bottom emitting method is used due to lack of light intensity in the edge light method.

For the large liquid crystal display, in addition to the current thinness and power saving feature, widening of the surface area and improvement of display quality are desired, which requires a large supply of light to the liquid crystal part. However, the light reflective sheets used in backlights of the large liquid crystal display will require high light reflectance of material per se, uniformity and rigidity for preventing distortion, flatness without warping and twisting (i.e. being not warped at almost equal degree in each side, but warped at two edges in diagonal direction), and a dimensional stability in which the dimension hardly changes, even under variations in temperature.

Regarding the backlights for a large liquid crystal display, problems such as the following occur when the reflective sheet lacks rigidity. Deflection and distortion are generated after the backlight is assembled, uniform light cannot be obtained on both sides causing brightness irregularity, and creating difficulties when punching-out the light reflective sheet and assembling backlight units. Warping and twisting in the light reflective sheet are not desired because no uniform light reflection can be obtained, therefore generating brightness irregularity, and creating problems when punching-out the light reflective sheet and assembling backlight units.

Also, as the output power of light source becomes larger due to higher brightness of a large liquid crystal display, temperature inside a backlight unit can rise up to 80 to 100° C. In the case of poor dimensional stability of light reflective sheet against temperature change, under a repeated rising and cooling of the temperature, the light reflective sheet fixed with a frame shrinks, which generates strains to cause irregularity of brightness. In worst case, this sometimes leads to a trouble in which the light reflective sheet becomes disengaged from the frame. Nowadays, liquid crystal televisions have become larger, 32 inches or more in mainstream, so that diagonal dimension used in the light reflective sheet is now as large as 82 cm or more, and when it shrinks even by 1%, there is a dimensional change of 8 mm. Minimizing this shrinkage is now of a serious issue.

Void containing PET sheets as light reflective sheets are widely used (e.g. see Patent reference 1), but there has been problems of poor ultraviolet yellowing resistance whereby the sheets turn yellow over time, and reflectance is lowered and brightness irregularity is generated. Also, there has been suggestions to use a reflective sheet made of polypropylene and obtained by stretching a sheet added with inorganic fillers (e.g. see Patent reference 2) as the main component, its rigidity is poor, deflection and distortion are generated as it is prone to deformation, no uniform light can be obtained on both sides, which generates irregularity of brightness, and creates difficulties when punching-out the light reflective sheet and assembling backlight units.

To solve these problems, there has been suggestions to use a light reflective sheet constituted by lamination of a polyolefin based sheet with voids formed by stretching a sheet added with fillers onto a thermoplastic resin substrate layer where voids are formed by using a foaming agent (e.g. see Patent reference 3). However, to obtain a light reflective sheet with intended reflecting characteristics, it is necessary to improve the reflecting characteristics of the olefin-based resin sheet with voids formed by stretching a sheet added with fillers, so that the olefin-based resin sheet must be thickened. Since the olefin-based resin sheet is stretched, it generates more strains than a non-stretched sheet, and tends to shrink by heating as well. In particular, this tendency grows in a biaxial stretching, where a non-stretched sheet is stretched in two directions, because orientation lengthwise is not uniform. When an olefin-based resin sheet with voids formed by such stretching and which has been thickened is laminated on a non-stretched sheet, the light reflective sheet tends to generate warping and twisting. When there is repeated rising and cooling of the temperature inside the backlight unit, these warps and twists become larger and leads warping and twisting of the light reflective sheet itself, or it may generate shrinkage, providing an insufficient flatness and dimensional stability required for the light reflective sheet of a large liquid crystal display.

Patent reference 1: JP 04-239540 (1992)

Patent reference 2: JP 06-298957 (1994)

Patent reference 3: JP 2004-309804

### DISCLOSURE OF THE INVENTION

### Problems to be Solved by the Invention

The present invention aims to solve the above-mentioned problems of conventional light reflective sheets and provide a light reflective sheet that, for example, has excellent light reflecting characteristics and ultraviolet yellowing resistance, good dimensional stability and rigidity.

### Means to Solve the Problems

The present inventors have studied extensively and, as a result, have discovered the following solutions to the present problems and have completed the present invention: A light reflective face comprising the void containing light reflective layer (B) on the light receiving side of a substrate layer (A) composed of a thermoplastic resin composition (a1) containing an inert particle of 5 to 40% in weight, and a backing layer (C) on the non-light receiving face of the substrate layer (A), wherein the void containing light reflective layer (B) is a uniaxially or biaxially stretched sheet with a thickness (tb) of 10 to 90 μm and diffuse reflectance of 70 to 90%.

The present invention constitutes the following.
1. A light reflective sheet comprising a substrate layer (A), a void containing light reflective layer (B) on the light receiving side of the substrate layer (A) and a backing layer (C) on the non-light receiving side of the substrate layer (A), wherein the substrate layer (A) contains a layer made of a thermoplastic resin composition (a1) containing an inert particle of 5 to 40% in weight, and the void containing light reflective layer (B) is a uniaxially or biaxially stretched sheet made of a thermoplastic resin with a thickness (tb) of 10 to 90 μm and diffuse reflectance of 70 to 90%.
2. The light reflective sheet described in 1, wherein the total reflectance is 70 to 98% and the total light transmittance of the substrate layer (A) is 10% or less.
3. The light reflective sheet described in 1 or 2, wherein the ratio (ta/tb) of the thickness (ta) of the substrate layer (A) to the thickness (tb) of the void containing light reflective layer (B) is 4.5 to 40.
4. The light reflective sheet described in any one of 1 to 3, wherein the substrate layer (A) is composed of at least two layers, one layer thereof touching the void containing light reflective layer (B) is made of the thermoplastic resin composition (a1), the thickness (ta1) is 30 to 1000 μm, and at least one other layer is made of a thermoplastic resin composition (a2) containing no inert particle.
5. The light reflective sheet described in any one of 1 to 4, wherein the inert particle in the thermoplastic resin composition (a1) is titanium dioxide.
6. The light reflective sheet described in any one of 1 to 5, wherein the thickness (tb) of the void containing light reflective layer (B) is 15 to 60 μm.
7. The light reflective sheet described in any one of 1 to 6, wherein the thermoplastic resin composition forming the void containing light reflective layer (B) contains an inert particle of 5 to 50% in weight, the inert particle is a thermoplastic resin composition (b1) containing a dicyclopentadiene petroleum resin with a softening point (ring ball method) of 160 to 200° C. and calcium carbonate with a mean particle diameter of 0.01 to 20 μm.
8. The light reflective sheet described in any one of 1 to 6, wherein the thermoplastic resin composition forming the void containing light reflective layer (B) contains an inert particle of 5 to 60% in weight, the inert particle is a thermoplastic resin composition (b1′) containing a dicyclopentadiene petroleum resin with a softening point (ring ball method) of 160 to 200° C., calcium carbonate with a mean particle diameter of 0.01 to 20 μm and titanium oxide.
9. The light reflective sheet described in any one of 1 to 8, wherein the void containing light reflective layer (B) is constituted by lamination of a surface layer made of a thermoplastic resin composition (b3) containing titanium dioxide of 5 to 30% in weight on at least one face made of the thermoplastic resin composition (b1) or the thermoplastic resin composition (b1′).
10. The light reflective sheet described in any one of 1 to 9, wherein the thermoplastic resins are the same kind of thermoplastic resin for creating the thermoplastic resin composition (a1), the thermoplastic resin composition (a2), the thermoplastic resin composition (b1) or the thermoplastic resin composition (b1′), and the thermoplastic resin composition (b3).
11. The light reflective sheet described in any one of 1 to 10, wherein the thermoplastic resins are a polypropylene resin for creating the thermoplastic resin composition (a1), the thermoplastic resin composition (a2), the thermoplastic resin composition (b1) or the thermoplastic resin composition (b1′), and the thermoplastic resin composition (b3).
12. The light reflective sheet described in any one of 1 to 6, wherein the thermoplastic resin composition forming the void containing light reflective layer (B) is a thermoplastic resin composition (b2) containing a polyolefin resin composed of crystalline polypropylene (PP) of 30 to 90% in weight and propylene-α-olefin copolymer (RC) of 10 to 70% in weight dispersed in the crystalline polypropylene, and the melt mass flow rate ratio MFR_{PP}/MFR_{RC} of melt mass flow rate MFR_{PP} of the crystalline polypropylene (PP) and melt mass flow rate MFR_{RC} of the propylene-α-olefin copolymer (RC) is 0.1 to 10.
13. The light reflective sheet described in 12, wherein the thermoplastic resin composition forming the void containing light reflective layer (B) is a thermoplastic resin composition (b2′) further containing titanium dioxide of 5 to 30% in weight in the thermoplastic resin composition (b2).
14. The light reflective sheet described in 12 or 13, wherein the void containing light reflective layer (B) is constituted by lamination of a surface layer made of the thermoplastic resin composition (b3) containing titanium dioxide of 5 to 30% in weight on at least one side of the layer composed of the thermoplastic resin composition (b2) or (b2′).
15. The light reflective sheet described in any one of 1 to 14, wherein the substrate layer (A) and the void containing light reflective layer (B) are laminated by extrusion laminating method.
16. The light reflective sheet described in any one of 1 to 15, wherein the backing layer (C) is at least of the kind selected from void containing light reflective layer (B), thermoplastic resin sheet containing essentially no void and metal evaporated sheet.

### EFFECT OF THE INVENTION

The light reflective sheet of the present invention is a light reflective sheet obtained by laminating a substrate layer (A) made of a thermoplastic resin composition containing a specific amount of inert particle and a void containing light reflective layer (B) made of a thermoplastic resin composition of a specific thickness. The thickness of the void containing light reflective layer (B) obtained by stretching is 10 to 90 μm, preferably as thin as 15 to 60 μm to suppress warping and twisting and improve flatness, reduce the influence of heat shrinkage specific to a stretched substance and improve dimensional stability against temperature change. Furthermore, at least on one side of the thermoplastic resin composition forming the substrate layer (A) in a melting state, the void containing light reflective layer (B) should be thermally pressure bonded and cooled to laminate the substrate layer (A) and the void containing light reflective layer (B), thereby significantly improving flatness and dimensional stability. Also, not only did it significantly improve the light reflecting characteristics, which could not be achieved by the substrate layer (A) or the void containing light reflective layer (B) alone, but it also improved the light reflecting characteristics and ultraviolet yellowing resistance by producing both layers with a polyolefin based resin. Namely, it is possible to provide a rigid light reflective sheet with excellent flatness and dimensional stability, and possessing excellent light reflecting characteristics and ultraviolet yellowing resistance.

### BEST MODE FOR CARRYING OUT THE INVENTION

Embodiments of the present invention will be described below. On the light reflective sheet of the present invention, a void containing light reflective layer (B), where voids are formed by stretching, is laminated to create a light receiving face on the substrate layer (A). On the light non-receiving face, a backing layer (C) is laminated in order to suppress warping deformation of the light reflective sheet. As the backing layer (C), it may employ the same sheet as the void containing light reflective layer (B), or it may employ a stretched sheet containing essentially no void, or a metal evaporated sheet and such.

(1) Substrate Layer (A)

The substrate layer (A) is made of a thermoplastic resin composition (a1) containing an inert particle of 5 to 40% in weight. Also, it may be a single layer made of a thermoplastic resin composition containing an inert particle in the entire layer, or it may be a multilayer structure. It is preferable that the total reflectance and light transmittance measured for the light receiving face can perform the following. From an economical point of view, it is preferable that the inert particle is added only in the outermost layer of multilayer structure (the layer touching the void containing light reflective layer (B), and that foamed sheets by chemical foaming and gas forming are employed.

For example, in the case of the multilayer structure where the substrate layer (A) is composed of at least two layers in which the outermost layer is made of the thermoplastic resin composition (a1), cost can be reduced by using a thermoplastic resin composition (a2) containing no inert particle for at least one of the layer other than the outermost layer.

There are no specific limitations on the thermoplastic resin composition used in the thermoplastic resin composition (a1). However, when the void containing light reflective layer (B) is placed on the light receiving side of membranous melt made of the thermoplastic resin composition (a1) forming the substrate layer (A) and the backing layer (C) is placed on the non-light receiving side, thermally pressure bonded, then cooled, in a method where the substrate layer (A), the void containing light reflective layer (B) and the backing layer (C) were laminated (hereinafter referred to as “extrusion laminating method”), a thermoplastic resin used in the substrate layer (A) and a thermoplastic resin used in the void containing light reflective layer (B) are preferably of the same kind. The thermoplastic resin used in the substrate layer (A) and the thermoplastic resin used in the backing layer (C) also preferably the same kind.

Additionally, in the case where the substrate layer (A), the void containing light reflective layer (B), and the backing layer (C) are a multi-layered structure themselves, it is sufficient that the thermoplastic resin used in the contact face of the substrate layer (A) and void containing light reflective layer (B), and the thermoplastic resin used in the contact face of the substrate layer (A) and backing layer (C) are all of the same kind. For example, in the case where the substrate layer (A) is a multi-layered structure, it is preferable that the thermoplastic resins of the thermoplastic resin compositions (a1), (a2) and other thermoplastic resin composition are of the same because the substrate layer (A) of multi-layered structure can be formed by the coextrusion method.

To be specific, the thermoplastic resins used in the present invention are polyolefin resins such as polypropylene resin, polyethylene resin, cycloolefin polymer and polymethylpentene resin; polyester resins such as polyethylene terephthalate resin and polyethylene naphthalate resin; polyamide resins such as nylon 6, nylon 66 and nylon 46, polystyrene resin, polyvinyl chloride resin, acryl resin, polycarbonate resin and fluorocarbon resin. The resins can be used alone or in combination.

Among them, from ultraviolet yellowing resistance and economical aspects, olefin resins such as polypropylene, polyethylene, cycloolefin polymer and polymethylpentene are preferable, especially the polypropylene resin.

There are no specific limitations on the inert particles used in the thermoplastic resin composition (a1), as long as they are inert to the thermoplastic resin used in the thermoplastic resin composition (a1). They are broadly classified into inorganic inert particles and organic inert particles. Listed as an inorganic inert particle include metal oxides such as silica, alumina, zirconia and titanium dioxide; composite oxides such as kaolin, zeolite, sericite and sepiolite; sulfates such as calcium sulfate and barium sulfate; phosphates such as calcium phosphate and zirconium phosphate; and carbonate such as calcium carbonate. Listed as an organic inert particle include silicone, thermoplastic resin, thermosetting resin, petroleum resin obtained from steam cracking of petroleum naphtha. And among them, white pigments such as titanium dioxide and barium sulfate are preferable, particularly titanium dioxide because of its high degree of whiteness. Also, these inert particles may be used alone or in combination of two or more. Particles with different mean diameters may be used concomitantly.

There are no specific limitations on the mean particle diameter of the inert particle. However, it is preferable that the diameter is between 0.01 to 50 μm, especially between 0.05 to 20 μm, and ideally between 0.1 to 5 μm. When the mean particle diameter is in the above range, performance of the thermoplastic resin composition (a1) is good, minute dispersion into the thermoplastic resin is easy, and reflecting characteristics of the light reflective sheet is easily obtained.

The percentage of the inert particle in the thermoplastic resin composition (a1) is 5 to 40% in weight, preferably 10 to 30%. When the percentage is in this higher range, it gives sufficient reflecting characteristics and enhances the processing of thermoplastic resin composition (a1) and the productivity of the substrate layer (A).

Also when necessary, the thermoplastic resin compositions (a1), (a2), and other thermoplastic resin composition composing the substrate layer (A), can be used together with compounded antioxidant, neutralizing agent, nucleus former, hindered amine-based weathering agent, ultraviolet absorbent, surfactant like antistatic agent, inorganic filler, lubricant, anti-blocking agent, antibacterial agent, antifungal agent and pigment that are used in ordinary thermoplastic resins.

The total reflectance of the substrate layer (A) depends on the roughness of its surface, but between 70 to 98% is preferable. Within this range, the total reflectance and brightness of the light reflective sheet is sufficient, the production process is simple and productivity is high.

For light transmittance of the substrate layer (A) of 10% or less is preferable because a light reflective sheet with sufficient total reflectance and brightness can be obtained.

Also, even when the total reflectance of the substrate layer (A) is 95%, in comparison with a light reflective sheet (200 μm thick) containing voids in the entire layer having the same total reflectance, the substrate layer (A) alone is difficult to use as a light reflective sheet due to low brightness. The light reflective sheet of the present invention exhibits excellent total reflectance and brightness by laminating a thin membrane of void containing light reflective layer (B) on the substrate layer (A) with a certain total reflectance.

There are no specific limitations on the thickness (ta) of the substrate layer (A). However, as the light reflective sheet obtained by laminating a void containing reflective layer (B) and its warping and degree of shrinkage after heating are influenced significantly by the thickness of the void containing layer, the preferable ratio (ta/tb) of the thickness (ta) of the substrate layer (A) to the thickness (tb) of the void containing reflective layer (B) is 4.5 to 40%.

From these viewpoints, the thickness (ta) of the substrate layer (A) should be between 100 and 5000 μm, but preferably between 100 and 2000 μm, and ideally between 200 and 1000 μm.

In the case of the multi-layered structure, in which the substrate layer (A) is constituted by at least two layers, the outermost layer touching the void containing reflective layer (B) is made of thermoplastic resin composition (a1), the thickness (ta1) should be between 30 and 1000 μm, but preferably between 40 and 500 μm. Also, costs can be lowered by using a thermoplastic resin composition (a2) containing no inert particle for at least one of the layer, other than the outermost layer.

When the thicknesses (ta) and (ta1) are in the above range, the reflecting characteristics necessary for a light reflective sheet is not only easily obtained, but also warping and degree of shrinkage after heating is hardly influenced by the void containing layer. Furthermore, in the extrusion laminating method, the amount of heat of the thermoplastic resin composition (a1) in a melting state is sufficient, and warping and shrinkage present in the void containing light reflective layer is eliminated when producing a light reflective sheet. Also, the warping, twisting and degree of shrinkage due to heating are small, so that it is easy to obtain flatness and dimensional stability necessary for the light reflective sheet.

The substrate layer (A) can be formed into a sheet by the well-known inflation sheet forming method, T-die sheet forming method, calendar forming method and using the well-known sheet forming apparatuses.

Also, lamination of the substrate layer (A) onto a void containing light reflective layer (B) can be conducted while forming it by using the extrusion laminating method.

(2) Void Containing Light Reflective Layer (B)

The void containing light reflective layer (B) contains an inert particle of 5 to 50% in weight. The inert particle is a thermoplastic resin composition (b1) containing a dicyclopentadiene petroleum resin with a softening point (ring ball method) of 160 to 200° C. and calcium carbonate with a mean particle diameter of 0.01 to 20 μm. Or it contains an inert particle of 5 to 60% in weight, and the inert particle is a thermoplastic resin composition (b1′) containing a dicyclopentadiene petroleum resin with a softening point (ring ball method) of 160 to 200° C., calcium carbonate with a mean particle diameter of 0.01 to 20 μm and titanium oxide. It is a uniaxially or biaxially stretched sheet composed thereof and has a thickness (tb) of 10 to 90 μm and a diffuse reflectance of 70 to 90%. The thermoplastic resin composition (b1) or (b1′) is melted, kneaded, and extruded into a membranous form, after which a sheet, preferably, obtained by stretching the cooled and solidified sheet in one or two directions is used.

Also, it is preferable that the void containing light reflective layer (B), in which the surface layer is composed of thermoplastic resin composition (b3) containing titanium dioxide of 5 to 30% in weight, is laminated on at least one side of the layer made of the thermoplastic resin composition (b1) or (b1′), because light reflective sheet with a high total reflectance and brightness can be obtained.

Additionally, in the case where the surface layer composed of thermoplastic resin composition (b3) is laminated on only one side, a protective layer containing no titanium dioxide may be laminated on the other side.

The thermoplastic resin used in the thermoplastic resin composition (b1) or (b1′) of the void containing light reflective layer (B), include polyolefin resins such as polypropylene, polyethylene and polymethylpentene; polyester resins such as polyethylene terephthalate; and polyethylene naphthalate, polyamide resins such as nylon 6, nylon 66 and nylon 46; polystyrene resin; polyvinyl chloride resin; acryl resin; polycarbonate resin and fluorocarbon resin. They can be used alone or in combination of two or more. Among them, the polypropylene resin is preferable when considering ultraviolet yellowing resistance and cost.

There are no specific limitations on the inert particle used in the thermoplastic resin composition (b1) or (b1′), as long as it is inert to the thermoplastic resin used in the thermoplastic resin composition (b1) or (b1′). The inorganic inert particle and organic inert particle used in the thermoplastic resin composition (a1) can be used, and these inert particles may be used alone, or in combination of two or more.

Among them, it is preferable that the thermoplastic resin composition (b1) contains an inert particle a dicyclopentadiene petroleum resin with a softening point (ring ball method) of 160 to 200° C. and calcium carbonate (with a mean particle diameter of 0.01 to 20 μm, preferably 0.01 to 10 μm, and ideally 0.1 to 5 μm), because a void containing light reflective layer (B) containing uniform and minute voids can be obtained by the foregoing stretching.

Also, adding titanium dioxide to the thermoplastic resin composition (b1′) is preferable because light reflecting characteristics of the void containing light reflective layer (B) are improved.

Examples of the above-described dicyclopentadiene petroleum resin with a softening point (ring ball method) of 160 to 200° C. contains petroleum resins (HR) obtained by polymerizing cyclopentadiene, dicyclopentadiene, their alkyl substitution products and oligomers, and distillates of at least one kind selected from the mixture as the main/largest component (hereinafter referred to as cyclopentadiene based component) obtained from steam cracking of petroleum naphtha, a petroleum resin with high softening point (HSHR) of high polymers with a softening point (ring ball method) in a range of 160 to 200° C. containing cyclopentadiene based component of 50% or more in weight; and in petroleum resins (HR), a hydrogenised dicyclopentadiene petroleum resin (HGHR) with a softening point (ring ball method) of 160 to 200° C. and iodine number of 20 or less or a mixture thereof obtained in such way that one containing cyclopentadiene based component of 50% or more in weight is hydrogenised using a metal or the metal oxide catalyst such as vanadium, nickel and cobalt under the presence of solvent at a temperature of 150 to 300° C. and a hydrogen pressure of 1 to 15 MPa.

There are no specific limitations on the mean particle diameter of the inert particle used in the thermoplastic resin composition (b1) or (b1′), but a diameter of 0.01 to 20 μm is preferable. The ideal is 0.1 to 10 μm. When the mean particle diameter is in the above range, workability of thermoplastic resin composition (a1) is good, minute dispersion into the thermoplastic resin is easy, stretching ability is good, and productivity is high.

The percentage of the inert particle in the thermoplastic resin composition (b1) should be 5 to 50% in weight, preferably 10 to 40%. Also, the percentage of the inert particle in the thermoplastic resin composition (b1′) should be 5 to 60% in weight, preferably 10 to 50%. When the percentage in the thermoplastic resin composition is in the above range, the formation of void is sufficient, the light reflecting characteristic of light reflective sheet is easy to obtain, and the stretching ability and productivity are also good.

The void containing light reflective layer (B) is formed from the thermoplastic resin composition (b1) or (b1′). It can also be composed of a thermoplastic resin composition (b2) containing a polyolefin resin of crystalline polypropylene (PP) of 30 to 90% in weight and propylene-α-olefin copolymer (RC) of 10 to 70% in weight dispersed in the crystalline polypropylene. The melt mass flow rate ratio MFR_{PP}/MFR_{RC} of melt mass flow rate MFR_{PP} of the crystalline polypropylene (PP) and melt mass flow rate MFR_{RC} of propylene-α-olefin copolymer (RC) being 0.1 to 10, it is a uniaxially or biaxially stretched sheet with a thickness (tb) of 10 to 90 μm and diffuse reflectance of 70 to 90%, the thermoplastic resin composition (b2) is melted and kneaded to give a membranous melt. The membranous melt is then formed into a membranous formed material, which is stretched uniaxially or biaxially at a temperature below the melting point of propylene-α-olefin copolymer (RC). Next, it is stretched uniaxially or biaxially at a temperature above the melting point of the propylene-α-olefin copolymer (RC) and below the melting point of crystalline polypropylene (PP), and a desirable sheet is produced.

Melt mass flow rate MFR is measured in accordance with JIS K 7210 at a measuring temperature of 230° C., and at a nominal load of 2.16 kg.

Also, when a thermoplastic resin composition forming the void containing light reflective layer (B) is the thermoplastic resin composition (b2′) formed by adding titanium dioxide to the thermoplastic resin composition (b2). The preferable amount of titanium dioxide is 5 to 30% in weight, and ideally be 10 to 30% because a light reflective sheet with high total reflectance and brightness can be obtained.

Furthermore, when the void containing light reflective layer (B) is constituted by laminating the surface layer, composed of the thermoplastic resin composition (b3) containing titanium dioxide of 5 to 30% in weight, on at least one side of the layer composed of the thermoplastic resin composition (b2) or (b2′). This is preferable because a light reflective sheet with high total reflectance and brightness can be obtained.

The crystalline polypropylene (PP) in the polyolefin resin used in the thermoplastic resin composition (b2) or (b2′) is a crystalline polymer with a mainly propylene polymerization unit. The polypropylene should preferably be 90% or more in weight of the total of the propylene polymerization unit. Specifically, it may be a homopolymer of propylene, or may be a random or block copolymer with 90% in weight or more of the propylene polymerization unit and less than 10% in weight of α-olefin. The α-olefins used in the case where a crystalline polypropylene (PP) is a copolymer, can be ethylene (included in α-olefin in the present invention), 1-butene, 1-pentene, 1-hexene, 1-octene, 1-decene, 1-dodecene, 4-methyl-1-pentene, and 3-methyl-1-pentene. With consideration to production cost, it is preferable to use a propylene homopolymer or a propylene-ethylene copolymer containing a propylene polymerization unit of 90% or more in weight.

Also, melt mass flow rate MFR of crystalline polypropylene (PP) should preferably be in a range of 0.1 to 50 g/10 min because of sheet forming stability.

The propylene-α-olefin copolymer (RC) in the polyolefin resin used in the thermoplastic resin composition (b2) or (b2′) is a random copolymer of propylene with α-olefin other than propylene. The content of propylene polymerization unit should preferably be 30 to 80 wt % relative to the total copolymer (RC). A more preferable range is 35 to 75 wt %, and the ideal range is 40 to 70 wt %. When the content of propylene polymerization unit is in the above range, pores are easily formed in domains of copolymer (RC) present in the matrix of crystalline polypropylene (PP), and characteristics of a light reflective sheet, the aim of the present invention, are easily obtained.

The α-olefins, other than the propylene used in copolymer (RC), include ethylene, 1-butene, 1-pentene, 1-hexene, 1-octene, 1-decene, 1-dodecene, 4-methyl-1-pentene, and 3-methyl-1-pentene. With consideration to production cost, it is preferable to use a propylene-ethylene copolymer using ethylene as α-olefin.

There are no specific limitations on melt mass flow rate MFR of copolymer (RC), but it should preferably be in a range of 0.1 to 20 g/10 min because of the ease in processing.

The polyolefin resin forming the thermoplastic resin composition (b2) or (b2′) is composed of crystalline polypropylene (PP) and copolymer (RC). There are no specific limitations on the melt mass flow rate ratio MFR_{PP}/MFR_{RC} (hereinafter referred to as “MFR ratio”) of the melt mass flow rate MFR_{PP} of crystalline polypropylene (PP) and the melt mass flow rate MFR_{RC} of copolymer (RC). From a processing point of view, the preferable ration is 0.1 to 10, especially 0.2 to 5, since copolymer (RC) is minutely dispersed in crystalline polypropylene (PP), and communicating minute pores and a high light reflectance are easily obtained.

Polyolefin resins forming the thermoplastic resin composition (b2) or (b2′) may employ any production method as long as the above conditions are satisfied. For example, a polyolefin resin may be produced through mixing by separately melt kneading polymerized crystalline propylene (PP) and copolymer (RC).

Also, it may be produced through multi-step polymerization by continuously polymerizing crystalline propylene (PP) and copolymer (RC). An example of this is a method that uses multiple polymerizing apparatuses in which crystalline propylene (PP) is produced in the first step, copolymer (RC) is then produced in the second step in the presence of crystalline propylene (PP) to give a mixed composition thereof continuously. This continuous polymerization method yields low production costs compared with the above melt mixing method. Also, it is preferable because an olefin resin that the copolymer (RC) is uniformly dispersed in crystalline polypropylene (PP) is stably obtained.

Additionally, in the case where the polyolefin resin composing the thermoplastic resin composition (b2) or (b2′) is continuously produced in the above-described multi-step polymerization, i.e. propylene (PP) is first polymerized, then copolymer (RC) is polymerized, since MFR_{RC} of copolymer (RC) cannot be directly measured, the MFR_{RC} is calculated by the following formula to determine the MFR ratio from the directly measurable MFR_{PP} of polypropylene (PP), melt mass flow rate MFR_{WHOLE} of the polyolefin resin, and content W_{RC} (% by weight) of copolymer (RC) in polyolefin resin:

log(MFR_{RC})={log(MFR_{WHOLE})−(1−W_{RC}/100)log(MFR_{PP})}/(W_{RC}/100)

### Such olefin resin can be produced specifically in the methods described in International Publication WO 97/19135 pamphlet and JP 08-27238 (1996).

Additionally, instead of using the olefin resin produced by the above methods, commercially available products that satisfy the given specifications may be used.

The thermoplastic resin composition (b2) or (b2′) may further contain an inert particle in the same manner as the thermoplastic resin composition (a1), in which the preferable diameter of the particle is 0.01 to 5 μm, especially 0.05 to 1 μm. When the particle diameter is in the above range, stretchability of thermoplastic resin composition (b2) is good, and minute dispersion into a thermoplastic resin is easy and reflecting characteristics necessary for a light reflective sheet is easily obtained.

The thickness of the void containing light reflective layer (B) should preferably be as thin as possible for improvement on dimensional stability of the light reflective sheet. However, it should preferably be as thick as possible for light reflecting characteristics such as total reflectance and brightness. Thus, the thickness should be 10 to 90 μm, and the range of 15 to 60 μm is preferable. When the thickness of the void containing light reflective layer (B) is in the above range, light reflecting characteristics are easily obtained, productivity is good, few warping and twist are generated in the laminating step, and strain and shrinkage such as warping and twisting when heating the light reflective sheet after lamination are small as well.

The void containing light reflective layer (B) should preferably have a larger diffuse reflectance, because it is necessary that voids are finely formed and thickness is increased, as well as the percentage of the voids is increased. However, when the thickness is increased, problems of warping and twisting arise in the lamination step, thus diffuse reflectance of 70 to 90% is used.

In the void containing reflective layer (B), the size of the void formed by stretching depends on the size of inert particle, stretching method, stretching ratio and the like. In biaxial stretching, the preferable lengths of void in the machine direction and transversal direction are about 0.5 to 50 μm, and the length in the thickness direction is about 0.1 to 5 μm.

Also, the percentage of void is calculated as a void rate in the following Formula (1). When the size of void is the same, the higher the void rate, the higher the content percentage of void.

Void rate (%)=[(ρ₀−ρ)/ρ₀]×100 Formula (1)

ρ₀ is the density in vacuum, ρ is the apparent density.

The preferable void rate of the void containing light reflective layer (B) of the present invention is 10 to 70%. When the void rate is in the above range, the desired light reflecting characteristic is obtained, and the productivity of the void containing light reflective layer (B) is good.

Also, the thermoplastic compositions (b1), (b1′), (b2) and (b2′), according to necessity, can be compounded with antioxidant, neutralizing agent, nucleus former, hindered amine-based weathering agent, ultraviolet absorbent, surfactant like antistatic agent, inorganic filler, lubricant, anti-blocking agent, antibacterial agent, antifungal agent and pigment used in the ordinary thermoplastic resins.

The void containing reflective layer (B) may be a single layer made of the thermoplastic composition (b1), (b1′), (b2) or (b2′), or may be a layer with a multilayer structure.

For example, for the void containing reflective layer (B) with a multilayer structure, when the void containing reflective layer (B) has a surface layer made of the thermoplastic resin composition (b3) containing titanium dioxide of 5 to 30% in weight laminated on at least one side of a layer made of the thermoplastic resin composition (b1), (b1′), (b2) or (b2′), a light reflective sheet with high total reflectance and brightness can be obtained. With consideration of the point of adhesion between the core layer and the surface layer, the thermoplastic resin used in the thermoplastic resin composition (b3) should ideally be the same kind of thermoplastic resin as the thermoplastic composition used in the thermoplastic composition (b1), (b1′), (b2) or (b2′). The thermoplastic resin composition (b3), when necessary, there can be compounded with antioxidant, neutralizing agent, nucleus former, hindered amine-based weathering agent, ultraviolet absorbent, surfactant like antistatic agent, inorganic filler, lubricant, anti-blocking agent, antibacterial agent, antifungal agent and pigment used in ordinary thermoplastic resins.

The void containing reflective layer (B) made of the thermoplastic resin composition (b1) or (b1′) is obtained by stretching a sheet formed by the well-known inflation sheet forming method, T-die sheet forming method, calendar forming method using the well-known sheet forming apparatuses, in one or two directions. In the case where the void containing reflective layer (B) is a multilayer structure, for example, the thermoplastic resin composition (b1) or (b1′) and thermoplastic resin composition (b3) are formed into a laminate sheet by the coextrusion method, and it is obtained by stretching this sheet in one or two directions.

Additionally, the stretching ratio should preferably be 4 times or more in area.

The void containing reflective layer (B) made of the thermoplastic resin composition (b2) or (b2′) is obtained by stretching a sheet formed by the well-known inflation sheet forming method, T-die sheet forming method, calendar forming method using the well-known sheet forming apparatuses, in one or two directions at a temperature below the melting point of propylene-α-olefin copolymer (RC), and then by stretching in one or two directions at a temperature above the melting point of propylene-α-olefin copolymer (RC) and below the melting point of crystalline polypropylene (PP). In the case where the void containing reflective layer (B) is a multilayer structure, for example, the thermoplastic resin composition (b2) or (b2′) and thermoplastic resin composition (b3) are formed into a laminate sheet by the coextrusion method. It is obtained by stretching this sheet uniaxially or biaxially at a temperature below the melting point of propylene-α-olefin copolymer (RC), then by stretching uniaxially or biaxially at a temperature above the melting point of propylene-α-olefin copolymer (RC) and below the melting point of crystalline polypropylene (PP).

Additionally, the stretching ratio should preferably be 4 times or more in area.

(3) Backing Layer (C)

To suppress warping and deformation of the light reflective sheet in the present invention, a backing layer (C) is laminated on the non-light receiving face. The backing layer (C) may be the same one used in the void containing reflective layer (B) of the light receiving face, or it may be a thermoplastic resin stretched sheet containing essentially no void being composed of a known thermoplastic resin as the main component (largest component in weight content percentage) and stretched in one direction or two directions is laminated. Also, when light transmittance of a light reflective sheet is large, light ray from a light source passes through the rear side of the light reflective sheet. To reduce the light transmittance of light reflective sheet, it is possible to enhance the total reflectance and brightness by laminating a metal evaporated sheet such as silver and aluminum as the backing layer (C).

There are no specific limitations on the thickness of backing layer (C), but it is preferable that the characteristics of the rigidity and degree of shrinkage when heating are the same level as those of the void containing reflective layer (B).

(4) Lamination of the Substrate Layer (A), Void Containing Reflective Layer (B) and Backing Layer (C).

As a method for laminating the substrate layer (A) and the void containing reflective layer (B), there is the thermal laminating method and the extrusion laminating method, as well as the well-known laminating methods using adhesive and agglutinant in dry lamination method, wet lamination method, and hot melt lamination. Among them, the extrusion laminating method is a method in which the thermoplastic resin composition (a1) composing a substrate layer (A) is melted and kneaded by an extruder and extruded through T-die into a membranous form. Or thermoplastic resin compositions (a1) and (a2) are each melted and kneaded by an extruder and coextruded through T-die into a membranous form, while lapping the membranous material in a melt state and the void containing reflective layer (B), and pressed/cooled by a pair of rolls. Furthermore, the process can be simplified since the void containing reflective layer (B) in the light reflective sheet of the present invention is thin. Through the heat amount of thermoplastic resin composition (a1), or thermoplastic resin compositions (a1) and (a2), it is possible to suppress strain and shrinkage generated by stretching the void containing reflective layer (B) when heating. Additionally, for laminating the backing layer (C), for example, in pressing/cooling by a pair of rolls while lapping a void containing reflective layer (B) on the molten membranous material for the substrate layer (A), the backing layer (C) can be lapped on the face of molten membranous material at the opposite side of the void containing reflective layer (B).

The light reflective sheet of the present invention should preferably have a total reflectance of 90 to 105% and diffuse reflectance of 85 to 100%.

### EXAMPLES

The present invention will be described specifically through the below Examples and Comparative examples, but is not limited thereto.

Tests of raw materials of the light reflective sheet in the present invention were conducted using the following methods.

(i) Mean Particle Diameter of Inert Particle

The major axis and minor axis of the inert particle were measured with an electron microscope. The average was used as the mean particle diameter of the inert particle, and this measurement was carried out on 100 random particles and the average mean particle diameter data of the 100 particles was defined as the mean particle diameter of the inert particle.

(ii) Melt Mass Flow Rate (MFR)

It was measured in accordance with JIS K 7210 at a test temperature of 230° C. and nominal load of 2.16 kg.

Additionally, evaluations of light reflective sheets in Examples and Comparative examples were conducted using the following methods.

### (1) Total Reflectance and Diffuse Reflectance

Total reflectance and diffuse reflectance were measured for the light receiving face of the light reflective sheet under the light receiving condition of 0° diffuse light in accordance with JIS Z-8722 “Methods of color measurement; Reflecting and transmitting objects”, using SD-5000 (trade name, manufactured by Nippon Denshoku Industries Co. Ltd).

### (2) Total Light Transmittance

The total light transmittance of the light reflective sheet was measured in accordance with JIS K-7105 “Testing methods for optical properties of plastics.”

### (3) Brightness

In accordance with Electronic Industries Association of Japan (EIAJ) standard ED-2522 “Measuring methods for matrix liquid crystal display modules,” using a 20 inches model liquid crystal display, setting in liquid crystal module/prism sheet/diffusing sheet/diffusing plate/cold cathode/reflective sheet, standing it still for 1 hour after turning on electricity in a normal white mode, brightness was measured at a center part of the liquid crystal display and 4 points apart from the center part each by 10 cm in longitudinal and lateral directions using a colorimeter (BM-5A, manufactured by Topcon Corporation). An average of 5 points was defined as the brightness.

### (4) Ultraviolet Yellowing Resistance

After an ultraviolet irradiation of 48 hours using an EYE Super UV tester (SUV-W151, manufactured by Iwasaki Electric Co. Ltd.), and under an ultraviolet strength of 1000 W/m² (295 to 450 nm wavelength region), black panel temperature of 60° C. and humidity of 50 RH %, then, using a spectral whiteness tester PF-10 (trade name, manufactured by Nippon Denshoku Industries Co. Ltd.), b value in Hunter Lab color system was measured. The difference (b−b₀) of the b value before and after the irradiation was defined as the ultraviolet yellowing resistance. It is shown that the smaller the value, the better the ultraviolet yellowing resistance.

### (5) Warping Deformation Before and after Heating

A light reflective sheet sample of 50 cm square with or without heat treatment (100° C., 24 hours) was allowed to stand at 25° C. and 65 RH % overnight, and was observed for warping at the 4 corners and 4 sides for the largest warping deformation. The degree of deformation was measured. It is shown that the smaller the value, the smaller the warping deformation. In general, warping deformation after heating must remain at 5 nun or less.

### (6) Degree of Shrinkage after Heating

For a light reflective sheet sample of 50 cm square, the dimensions were measured precisely in the longitudinal and lateral directions. After conducting a heat treatment (100° C., 24 hours), it was allowed to stand overnight at 25° C. and 65 RH %, and the dimensions were measured in the longitudinal and lateral directions to calculate the degree of shrinkage after heating. It is shown that the smaller the value, the better the dimensional stability.

### Example 1

### Preparation of the Thermoplastic Resin Composition (b1) for the Medium Layer of Void Containing Light Reflective Layer (B)

Added to the thermoplastic resin composition (b1) capable of forming void by stretching being used in a medium layer of a void containing light reflective layer (B) with a three layer structure were crystalline propylene homopolymer powder with MFR of 2 g/10 min having boiling heptane insoluble of 96% in weight, 0.03 parts in weight of phenol-based antioxidant BHT, 0.02% in weight of lactone-based antioxidant, 0.05% in weight of phosphorous-based antioxidant, 0.2% in weight of benzophenone-based ultraviolet absorbent, 0.2% in weight of benzotriazole-based ultraviolet absorbent, 0.8% in weight of hindered amine-based light stabilizer, 0.1 parts in weight of calcium stearate, 10% in weight of dicyclopentadiene petroleum resin with a softening point of 172° C. (hereinafter referred to as DCPD), 10% in weight of calcium carbonate (mean particle diameter of 1.0 μm) and 5% in weight of titanium dioxide (mean particle diameter of 0.3 μm). They were placed into a Henschel mixer (trade name), blended and stirred. Using a twin extruder of the same direction-rotating model, the stirred material was melted and kneaded at 240° C. to be extruded as a strand, which was then cooled and cut to give a pellet-shaped thermoplastic resin composition (b1).

Preparation of the Thermoplastic Resin Composition (b3) for the Surface Layer 1 of Void Containing Light Reflective Layer (B)

Added to the thermoplastic resin composition (b3) used in surface layer 1 to be laminated on the face of light source side when used as light reflective sheet in a void containing light reflective layer (B) with a three layer structure, in the same manner as in composition (b1), were crystalline propylene homopolymer powder with MFR of 2 g/10 min were added 10% in weight of titanium dioxide (mean particle diameter of 0.3 μm), 0.03 parts in weight of phenol-based antioxidant BHT, 0.02% in weight of lactone-based antioxidant, 0.05% in weight of phosphorous-based antioxidant, 0.1% in weight of benzophenone-based ultraviolet absorbent, 0.1% in weight of benzotriazole-based ultraviolet absorbent and 0.1 parts in weight of calcium stearate. They were added into a Henschel mixer (trade name), mixed and stirred. Using a twin extruder of same direction-rotating model, the stirred material was melted and kneaded at 240° C. to be extruded as a strand, which was then cooled and cut to give a pellet-shaped thermoplastic resin composition (b3).

Preparation of Thermoplastic Resin Composition (b4) for Surface Layer 2 of Void Containing Light Reflective Layer (B)

Added to the thermoplastic resin composition (b4) used in surface layer 2 to be laminated on the opposite side of surface layer 1 of a medium layer in a void containing light reflective layer (B) with a three layer structure, in the same manner as in composition (b1), were crystalline propylene homopolymer powder with MFR of 2 g/10 min were added 0.03 parts in weight of phenol-based antioxidant BHT, 0.02% in weight of lactone-based antioxidant, 0.05% in weight of phosphorous-based antioxidant, 0.1% in weight of benzophenone-based ultraviolet absorbent, 0.1% in weight of benzotriazole-based ultraviolet absorbent and 0.1 parts in weight of calcium stearate. They were added into a Henschel mixer (trade name), mixed and stirred. The stirred material was then supplied to a twin extruder of same direction-rotating model, melted and kneaded at 240° C. to be extruded as a strand, which was then cooled and cut to give a pellet-shaped thermoplastic resin composition (b4).

Preparation of Void Containing Light Reflective Layer (B)

Using a three-kind three-layer sheet extruder equipped with a multilayer T-die (one single screw extruder with a diameter of 90 mm for medium layer and two single screw extruders with a diameter of 50 mm for surface layer) and a sequentially biaxial stretching machine of the tentering method, the above thermoplastic resin composition (b1) was supplied to the extruder for medium layer. The above thermoplastic resin compositions (b3) and (b4) were supplied separately to the extruders for surface layer, melted and coextruded at a T-die temperature of 240° C., rapidly cooled by a cooling roll of mirror finished surface at a surface temperature of 30° C., thereby producing a 3-kind 3-layer unstretched sheet in constitution of surface layer 1/medium layer/surface layer 2 (constitutional ratio of thickness: 1:4:1).

The unstretched sheet was introduced to a longitudinal stretching machine and stretched 5 times between heated rollers at 140° C. in the machine direction (MD), then stretched 8 times in the transverse direction (TD) in a tenter inner temperature of 160 to 210° C., to give a void containing light reflective layer (B) with a total thickness of 30 μm.

Preparation of Thermoplastic Resin Composition (a1) for Surface Layer of Substrate Layer (A)

Added to the thermoplastic resin composition (a1) touching a void containing light reflective layer (B) used in substrate layer (A), were crystalline propylene homopolymer powder with MFR of 7 g/10 min having boiling heptane insoluble of 96% in weight were added 15% in weight of titanium dioxide (mean particle diameter of 0.3 μm), 10% in weight of talc, 0.03 parts in weight of phenol-based antioxidant BHT, 0.02% in weight of lactone-based antioxidant, 0.05% in weight of phosphorous-based antioxidant, 0.2% in weight of benzophenone-based ultraviolet absorbent, 0.2% in weight of benzotriazole-based ultraviolet absorbent, 0.8% in weight of hindered amine-based light stabilizer, 0.1 parts in weight of calcium stearate. They were placed into a Henschel mixer (trade name), mixed and stirred. The stirred material was then supplied to a twin extruder of same direction-rotating model, melted and kneaded at 240° C. to be extruded as a strand, which was then cooled and cut to give a pellet-shaped thermoplastic resin composition (a1).

Preparation of Substrate Layer (A) and, Lamination of Substrate Layer (A) and Void Containing Light Reflective Layer (B)

Using a T-die sheet forming apparatus equipped with a T-die of 1000 mm in lip width being constituted by an extruder (E) of 65 mm diameter for medium layer, the above-described thermoplastic resin composition (a1) for substrate layer (A) was introduced to the extruder, melted at an extruding temperature of 240° C., extruded through a T-die whose lip clearance was adjusted to 1.0 mm into a membranous form to yield a membranous melt. While the membranous melt was sandwiched between two pieces of void containing light reflective layer (B), it was pressure bonded by a pair of mat roll with surface roughness of 50 μm (preset temperature of 40° C.) and rubber roll (preset temperature of 30° C.), cooled and solidified on the mat roll, then relaxed on an annealing roll at 80° C., thereby giving a light reflective sheet with a 800 mm width, a total thickness of 300 μm and a substrate layer (A) with a 240 μm thickness. (B: 30 μM/A: 240 μm/B: 30 μm). Additionally, the void containing light reflective layer (B) on the face that is not used as a light reflective sheet is used as a backing layer (C). The constitution and characteristic of the light reflective sheet obtained are shown in Table 1.

### Examples 2 and 3

They were conducted in the same manner as in Example 1, except that the thicknesses of the substrate layer (A) were 540 μm and 940 μm, respectively. The total thicknesses of the layers were 600 μm and 1000 μm, respectively. The constitution and characteristic of the light reflective sheet obtained are shown in Table 1.

### Examples 4 and 5

They were conducted in the same manner as in Example 1, except that the thicknesses of the void containing light reflective layer (B) were 60 μm and 90 μm, respectively. The thicknesses of the substrate layer (A) were 480 μm and 820 μm, respectively, and the thicknesses of the entire layer were 600 μm and 1000 μm. The constitution and characteristic of the light reflective sheet obtained are shown in Table 1.

### Examples 6 and 7

They were conducted in the same manner as in Example 2, except that the percentages of titanium dioxide in the thermoplastic resin composition (a1) were 7.5% in weight and 30% in weight, respectively. The constitution and characteristic of the light reflective sheet obtained are shown in Table 1.

### Example 8

It was conducted in the same manner as in Example 1, except that the percentage of titanium dioxide in the thermoplastic resin composition (b1) for the surface layer 1 of the void containing light reflective layer (B) was 0% in weight. The constitution and characteristic of the light reflective sheet obtained are shown in Table 1.

### Example 9

It was conducted in the same manner as in Example 1, except that in the lamination of substrate layer (A) and void containing light reflective layer (B), a biaxially stretched polypropylene sheet (thickness of 20 μm) containing no void was used as the backing layer (C) in place of the void containing light reflective layer (B) on the face not used as the light reflective sheet. The constitution and characteristic of the light reflective sheet obtained are shown in Table 1.

### Example 10

It was conducted in the same manner as in Example 1, except that in the lamination of the substrate layer (A) and void containing light reflective layer (B), in place of the void containing light reflective layer (B) on the face not used as a light reflective sheet, an aluminum evaporated sheet with a thickness of 24 μm where a biaxially stretched polypropylene sheet (thickness of 12 μm) was evaporated/deposited with aluminum was laminated on the aluminum evaporated face by dry lamination method.

### Example 11

### Preparation of Thermoplastic Resin Layer (a2) for Medium Layer of Substrate Layer (a)

Added to the thermoplastic resin composition (a2) used in substrate layer (A2) not touching the void containing light reflective layer (B) in substrate layer (A) with a two layer structure, were crystalline polypropylene powder with MFR of 7 g/10 min were added 0.03 parts in weight of phenol-based antioxidant BHT, 0.02% in weight of lactone-based antioxidant, 0.05% in weight of phosphorous-based antioxidant, 0.1% in weight of benzophenone-based ultraviolet absorbent, 0.1% in weight of benzotriazole-based ultraviolet absorbent and 0.1 parts in weight of calcium stearate. They were placed into a Henschel mixer (trade name), mixed and stirred, then introduced to a twin extruder of same direction-rotating model, melted and kneaded at 240° C. to be extruded as a strand, which was cooled and cut to give a pellet-shaped thermoplastic resin composition (a2).

Preparation of Substrate Layer (A), and Lamination of Substrate Layer (A) and Void Containing Light Reflective Layer (B)

Using a T-die sheet-forming apparatus equipped with a T-die of 1000 mm in lip width constituted by a three-kind three-layer sheet extruder equipped with a multilayer T-die (one single screw extruder with a diameter of 90 mm for medium layer and two single screw extruders with a diameter of 50 mm for surface layer), the above-described thermoplastic resin composition (a1) for substrate layer (A) was introduced to two single extruders for the surface layer. (a2) was introduced to the single extruder for medium layer, melted at an extruding temperature of 240° C., extruded through a T-die whose lip clearance was adjusted to 1.0 mm into a membranous form to yield a membranous melt. While the membranous melt was sandwiched between two pieces of void containing light reflective layer (B), it was pressure bonded by a pair of mat roll with surface roughness of 50 μm (preset temperature of 40° C.) and rubber roll (preset temperature of 30° C.), cooled and solidified on the mat roll, then relaxed on an annealing roll at 80° C., thereby giving a light reflective sheet with 800 mm width with a total thickness of 300 μm, and a 240 μm thickness of the substrate layer (A) (b1: 30 μm/a1: 50 μm/a2: 140 μm/a1: 50 μm/b1: 30 μm). Additionally, the layer composed of b1 on the face not used as a light reflective sheet is used as a backing layer (C). The constitution and characteristic of the light reflective sheet obtained are shown in Table 1.

### Example 12

### Preparation of Thermoplastic Resin Composition (b2) for Medium Layer of Void Containing Light Reflective Layer (B)

Added to a polyolefin resin, produced according to the methods described in International Publication WO 97/19135 pamphlet, and composed of 83.5% in weight of crystalline propylene homopolymer with MFR_{PP} of 3.2 g/10 min and 16.5% in weight of propylene-ethylene copolymer with MFR_{RC} of 1.6 g/10 min having propylene content of 64% in weight, being MFR ratio (MFR_{PP}/MFR_{RC}) of 2, were 0.1% in weight of terakis[methylene-3-(3′,5′-di-t-butyl-4′-hydroxyphenyl)propionate]methane as phenol-based antioxidant, 0.1% in weight of tris(2,4-di-t-butylphenyl)phosphite as phosphorous antioxidant, 0.1% in weight of calcium stearate as neutralizing agent. They were placed in a Henschel mixer (trade name), then melted and kneaded using a twin screw extruder (diameter of 50 mm), and palletized to give a thermoplastic resin composition (b2).

Preparation of Void Containing Light Reflective Layer (B)

Using a 20 mm extruder equipped with a T-die of 120 mm in lip width, the above-described thermoplastic resin composition (b2) was melted at 280° C. of extruding temperature and 4 kg/h of discharge rate, extruded through a T-die whose clearance was adjusted to 1.00 mm into a membranous form, cooled and solidified on a cooling roll at 80° C., to prepare a membranous material with 100 mm width and 270 μm thickness. The membranous material was stretched under a stretching temperature of 23° C., deformation velocity of 200%/sec and stretching ratio of 3 fold in the transverse direction (TD) while constraining the machine direction (MD). It was further stretched in the machine direction (MD) under a stretching temperature of 100° C., deformation velocity of 1000%/sec and stretching ratio of 3 fold, thereby giving a void containing light reflective layer (B).

It was conducted in the same manner as in Example 1, except that the void containing light reflective layer (B) was replaced by this thermoplastic resin composition (b2). The constitution and characteristic of the light reflective sheet obtained are shown in Table 3.

### Comparative Example 1

It was conducted in the same manner as in Example 1, except that the void containing light reflective layer (B) was not used, and the thickness of the substrate layer (A) was 300 μm. The constitution and characteristic of the light reflective sheet obtained are shown in Table 2. Brightness was insufficient although diffuse reflectance of the light reflective sheet obtained was good.

### Comparative Example 2

It was conducted in the same manner as in Example 1, except that a substrate layer (A) was not used, and the thickness of the void containing light reflective layer (B) was 300 μm. The constitution and characteristic of the light reflective sheet obtained are shown in Table 2. Although diffuse reflectance and brightness of the light reflective sheet obtained were good, warping deformation after heat treatment (100° C., 24 hours) was large, and the degree of heat shrinkage was also high and dimensional stability was poor.

### Comparative Examples 3 and 4

They were conducted in the same manner as in Example 1, except that the thickness of the void containing light reflective layer (B) was 100 μm, and the thicknesses of the substrate layer (A) were 100 μm and 400 μm, respectively. The thicknesses of entire layer were 300 μm and 600 μm, respectively. The constitution and characteristic of the light reflective sheet obtained are shown in Table 2. Although diffuse reflectance and brightness of the light reflective sheet obtained were good, warping deformation after heat treatment (100° C., 24 hours) was large, the degree of heat shrinkage was also high, and the dimensional stability was poor.

### Comparative Examples 5 and 6

They were conducted in the same manner as in Example 1, except that the thicknesses of the void containing light reflective layer (B) were 100 μm and 200 μm, respectively, the thicknesses of substrate layer (A) were 800 μm and 600 μm, respectively, and the thickness of the entire layer was 1000 μm. The constitution and characteristic of the light reflective sheet obtained are shown in Table 2. Although the diffuse reflectance and brightness of the light reflective sheet obtained were good, warping deformation after heat treatment (100° C., 24 hours) was large, and the degree of heat shrinkage was also high and dimensional stability was poor.

### Comparative Example 7

Preparation of Thermoplastic Resin Composition (b2′) for Medium Layer of Void Containing Light Reflective Layer (B)

Added to the polyolefin resin, produced according to the methods described in International Publication WO 97/19135 pamphlet, composed of 80.0% in weight of crystalline propylene homopolymer with MFR_{PP} of 22 g/10 min and 20.0% in weight of propylene-ethylene copolymer with MFR_{RC} of 0.3 g/10 min having propylene content of 50% in weight, being MFR ratio (MFR_{PP}/MFR_{RC}) of 75, were 0.1% in weight of terakis[methylene-3-(3′,5′-di-t-butyl-4′-hydroxyphenyl)propionate]methane as phenol-based antioxidant, 0.1% in weight of tris(2,4-di-t-butylphenyl)phosphite as phosphorous antioxidant, 0.1% in weight of calcium stearate as neutralizing agent. They were mixed with a Henschel mixer (trade name), then melted and kneaded using a twin screw extruder (diameter of 50 mm), and palletized to give a thermoplastic resin composition (b2′).

Preparation of Void Containing Light Reflective Layer (B)

Using a 20 mm extruder equipped with a T-die of 120 mm in lip width, the above-described thermoplastic resin composition (b2′) was melted at an extruding temperature of 280° C. and a discharge rate of 4 kg/h, extruded through a T-die whose clearance was adjusted to 1.00 mm into a membranous form, cooled and solidified on a cooling roll at 80° C., to prepare a membranous material with 100 mm width and 200 μm thickness. The membranous material was stretched under a stretching temperature of 23° C., deformation velocity of 200%/sec and stretching ratio of 3 fold in the transverse direction (TD) while constraining the machine direction (MD). When stretching in transverse direction, break occurred at a stretching ratio of less than 1.5 fold, stretchability was poor, characteristic of a void containing light reflective layer (B) could not be obtained when stretching at a small 1.2 fold of stretching ratio. See Table 3.

### Comparative Example 8

The performance of a polyester based light reflective sheet with voids formed by stretching with a total reflectance of 98%, total light transmittance of 2.2% and thickness of 250 μm, was evaluated. The characteristics obtained are shown in Table 2. Although the total reflectance and brightness were good, ultraviolet yellowing resistance was markedly poor, and the degree of heat shrinkage was also high.

Table 1

Table 2

Table 3

### Industrial Application Field

The light reflective sheet of the present invention is a light reflective sheet obtained by laminating a substrate layer (A) with specific light reflecting characteristic and a void containing light reflective layer (B) with specific thickness. And while maintaining its rigidity, the influence of degree of shrinkage in heating specific to a stretched substance was reduced, and its dimensional stability against temperature change was improved. Also, light reflecting characteristic that could not be achieved from the substrate layer (A) or the void containing light reflective layer (B) alone was greatly improved, while excellent ultraviolet yellowing resistance was obtained by employing polyolefin based resin in both layers. Therefore, this sheet is desirable as the light reflective sheet used in the backlight unit of liquid crystal display.

### BRIEF DESCRIPTION OF THE DRAWINGS

FIG. 1 shows an example of bottom emitting method backlight unit and liquid crystal display.

FIG. 2 shows an example of light reflective sheet of the present invention.

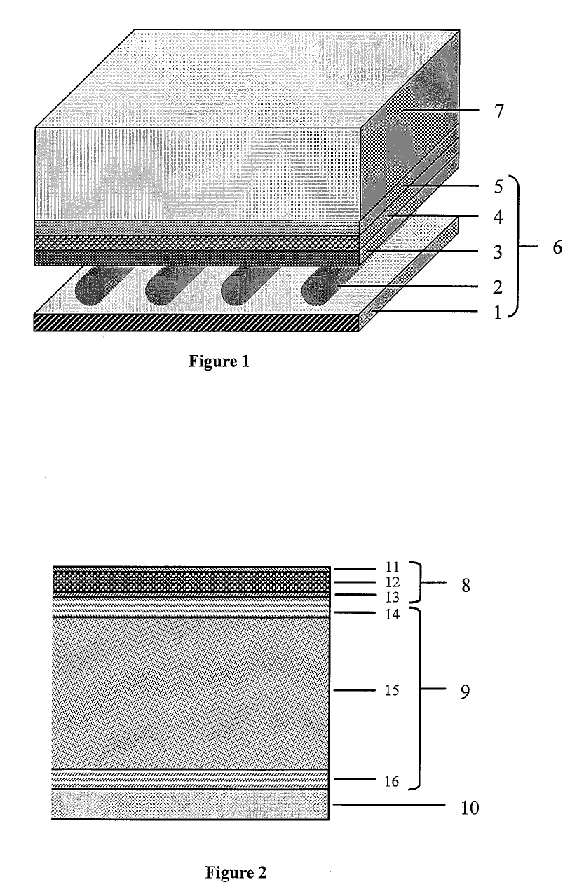

### DESCRIPTION OF NUMBER AND SYMBOL

1. Light reflective sheet
2. Light source (lamp)
3. Diffusing sheet
4. Prism sheet
5. Protect sheet
6. Backlight unit
7. Liquid crystal display
8. Void containing light reflective layer (B)
9. Substrate layer (A)
10. Backing layer (C)
11. Surface layer at light receiving side of void containing light reflective layer (B)
12. Medium layer of void containing light reflective layer (B)
13. Surface layer of non-light receiving face of void containing light reflective layer (B)
14. Surface layer of substrate layer (A) touching void containing light reflective layer (B)
15. Medium layer of substrate layer (A) not touching void containing light reflective layer (B)
16. Surface layer of substrate layer (A) at backing layer (C) side

TABLE 1

| | | | | | Example 1 | Example 2 | | Example 3 | | Example 4 | Example 5 |
|---|---|---|---|---|---|---|---|---|---|---|---|
| Constitution of light | Void containing light reflective layer (B) | | | | | | | | | | |
| reflective sheet | Surface layer 1*¹ | Thickness | | μm | 5 | | | | | 10 | 15 |
| | | Inert particle | Titanium dioxide | wt % | 10 | | | | | 10 | 10 |
| | Medium layer | Thickness | | μm | 20 | | | | | 40 | 60 |
| | | Inert particle | Calcium carbonate | wt % | 10 | | | | | 10 | 10 |
| | | | Petroleum resin | wt % | 10 | | | | | 10 | 10 |
| | Surface layer2*¹ | Thickness | | μm | 5 | | | | | 10 | 15 |
| | | Inert particle | | wt % | none | | | | | none | none |
| | Entire layer | Thickness (tb) | | μm | 30 | {close oversize bracket} | same | {close oversize bracket} | same | 60 | 90 |
| | | Reflecting | Total reflectance | % | 81 | | as left | | as left | 86 | 89 |
| | | characteristics | Diffuse reflectance | % | 77 | | | | | 83 | 87 |
| | | Total light | | % | 25 | | | | | 16 | 11 |
| | | transmittance | | | | | | | | | |
| | | Degree of heat | MD | % | 1.8 | | | | | 1.8 | 1.7 |
| | | shrinkage | TD | % | 0.4 | | | | | 0.4 | 0.4 |
| | | (100° C.) | | | | | | | | | |

| Substrate layer (A) | | | | | | | | |
|---|---|---|---|---|---|---|---|---|
| Surface layer 1 | Thickness | | μm | — | — | — | — | — |
| | Inert particle | Titanium dioxide | wt % | — | — | — | — | — |
| | | Talc | wt % | — | — | — | — | — |
| Medium layer | Thickness | | μm | 240 | 540 | 940 | 480 | 820 |
| | Inert particle | Titanium dioxide | wt % | 15 | 15 | 15 | 15 | 15 |
| | | Talc | wt % | 10 | 10 | 10 | 10 | 10 |
| Surface layer 2 | Thickness | | μm | — | — | — | — | — |
| | Inert particle | Titanium dioxide | wt % | — | — | — | — | — |
| | | Talc | wt % | — | — | — | — | — |
| Entire layer | Thickness (ta) | | μm | 240 | 540 | 940 | 480 | 820 |
| | ta/tb | | | 8.0 | 18 | 31 | 8.0 | 9.1 |
| | Reflecting | Total reflectance | % | 93 | 93 | 94 | 93 | 94 |
| | characteristics | Diffuse reflectance | % | 92 | 92 | 92 | 92 | 92 |
| | Total light | | % | 3.0 | 1.1 | 0.7 | 1.2 | 0.7 |
| | transmittance | | | | | | | |

| | Backing layer (C) | | | | | | | |
|---|---|---|---|---|---|---|---|---|
| | Same as void containing light reflective layer (B) | | | ◯ | ◯ | ◯ | ◯ | ◯ |
| | Biaxially stretched film (20 μm) | | | — | — | — | — | — |
| | Aluminum evaporated film (24 μm) | | | — | — | — | — | — |
| Characteristics | 1) Thickness | | μm | 300 | 600 | 1000 | 600 | 1000 |
| | 2) Reflecting characteristics | Total reflectance | % | 97 | 97 | 98 | 97 | 98 |
| | | Diffuse reflectance | % | 94 | 95 | 95 | 95 | 96 |
| | 3) Total light transmittance | | % | 2.2 | 0.6 | 0.4 | 0.6 | 0.3 |
| | 4) Brightness | | cd | 435 | 437 | 439 | 439 | 441 |
| | 5) UV inducing yellowing | | | 0 | 0 | 0 | — | — |
| | resistance (b − b₀) | | | | | | | |
| | 6) Warping defromation | Before heat | mm | 2.0 | 1.5 | 1.0 | 1.5 | 1.0 |
| | | treatment | | | | | | |
| | | After heat treatment | mm | 3.0 | 2.0 | 1.5 | 2.0 | 2.0 |
| | 7) Degree of heat shrinkage | MD | % | 0.2 | 0.2 | 0.2 | 0.3 | 0.5 |
| | (100° C.) | TD | % | 0.1 | 0.1 | 0.1 | 0.1 | 0.1 |

| | | | | | Exam- | | | Exam- | | | | Exam- |
|---|---|---|---|---|---|---|---|---|---|---|---|---|
| | | | | | ple 6 | Example 7 | | ple 8 | Example 9 | Example 10 | | ple 11 |
| Constitution of | Void containing light reflective layer (B) | | | | | | | | | | | |
| light reflective | Surface layer | Thickness | | μm | 5 | | | 5 | 5 | | | 5 |
| sheet | 1*¹ | Inert particle | Titanium dioxide | wt % | 10 | | | 0 | 10 | | | 10 |
| | Medium layer | Thickness | | μm | 20 | | | 20 | 20 | | | 20 |
| | | Inert particle | Calcium carbonate | wt % | 10 | | | 10 | 10 | | | 10 |
| | | | Petroleum resin | wt % | 10 | | | 10 | 10 | | | 10 |
| | Surface layer | Thickness | | μm | 5 | | | 5 | 5 | | | 5 |
| | 2*¹ | Inert particle | | wt % | none | | | none | none | | | none |
| | Entire layer | Thickness (tb) | | μm | 30 | {close oversize bracket} | same | 30 | 30 | {close oversize bracket} | same | 30 |
| | | Reflecting | Total reflectance | % | 80 | | as left | 76 | 80 | | as left | 81 |
| | | characteristics | Diffuse reflectance | % | 75 | | | 70 | 75 | | | 77 |
| | | Total light | | % | 25 | | | 35 | 25 | | | 25 |
| | | transmittance | | | | | | | | | | |
| | | Degree of heat | MD | % | 1.8 | | | 1.8 | 1.8 | | | 1.8 |
| | | shrinkage | TD | % | 0.4 | | | 0.4 | 0.4 | | | 0.4 |
| | | (100° C.) | | | | | | | | | | |

| Substrate layer (A) | | | | | | | | | | | |
|---|---|---|---|---|---|---|---|---|---|---|---|
| Surface layer 1 | Thickness | | μm | — | — | — | | | | | 50 |
| | Inert particle | Titanium dioxide | wt % | — | — | — | | | | | 15 |
| | | Talc | wt % | — | — | — | | | | | 10 |
| Medium layer | Thickness | | μm | 540 | 540 | 240 | | | | | 140 |
| | Inert particle | Titanium dioxide | wt % | 7.5 | 30 | 15 | | | | | none |
| | | Talc | wt % | 10 | 10 | 10 | | | | | none |
| Surface layer 2 | Thickness | | μm | — | — | — | | | | | 50 |
| | Inert particle | Titanium dioxide | wt % | — | — | — | {close oversize bracket} | same | {close oversize bracket} | same | 15 |
| | | Talc | wt % | — | — | — | | as left | | as left | 10 |
| Entire layer | Thickness (ta) | | μm | 540 | 540 | 240 | | | | | 240 |
| | ta/tb | | | 17 | 17 | 8.0 | | | | | 8.0 |
| | Reflecting | Total reflectance | % | 93 | 94 | 93 | | | | | 92 |
| | characteristics | Diffuse reflectance | % | 91 | 93 | 92 | | | | | 91 |
| | Total light | | % | 1.6 | 0.9 | 3.0 | | | | | 3.5 |
| | transmittance | | | | | | | | | | |

| | Backing layer (C) | | | | | | | | |
|---|---|---|---|---|---|---|---|---|---|
| | Same as void containing light reflective layer (B) | | | ◯ | ◯ | ◯ | — | — | ◯ |
| | Biaxially stretched film (20 μm) | | | — | — | — | ◯ | — | — |
| | Aluminum evaporated film (24 μm) | | | — | — | — | — | ◯ | — |
| Characteristics | 1) Thickness | | μm | 600 | 600 | 300 | 300 | 300 | 300 |
| | 2) Reflecting characteristics | Total reflectance | % | 96 | 97 | 93 | 96 | 97 | 96 |
| | | Diffuse reflectance | % | 94 | 95 | 91 | 94 | 94 | 93 |
| | 3) Total light transmittance | | % | 3.2 | 0.8 | 5.2 | 3.0 | 0.0 | 2.5 |
| | 4) Brightness | | cd | 435 | 436 | 430 | 434 | 441 | 431 |
| | 5) UV inducing yellowing | | | — | — | — | — | — | — |
| | resistance (b − b₀) | | | | | | | | |
| | 6) Warping defromation | Before heat | mm | 2.0 | 2.0 | 3.0 | 2.0 | 2.0 | 2.0 |
| | | treatment | | | | | | | |
| | | After heat treatment | mm | 3.0 | 3.0 | 2.0 | 3.0 | 3.0 | 3.0 |
| | 7) Degree of heat shrinkage | MD | % | 0.2 | 0.2 | 0.2 | 0.2 | 0.2 | 0.2 |
| | (100° C.) | TD | % | 0.1 | 0.1 | 0.1 | 0.1 | 0.1 | 0.1 |

*1 Surface layer 1 of substrate layer (A) shows a layer at light receiving side, surface layer 2 shows a layer at light non-receiving side

TABLE 2

| | | | | | Com- | Com- | Com- | Com- | Com- | Com- | Com- |
|---|---|---|---|---|---|---|---|---|---|---|---|
| | | | | | parative | parative | parative | parative | parative | parative | parative |
| | | | | | exam- | exam- | exam- | exam- | exam- | exam- | exam- |
| | | | | | ple 1 | ple 2 | ple 3 | ple 4 | ple 5 | ple 6 | ple 8 |
| Constitution of | Void containing light reflective layer (B) | | | | | | | | | | |
| light reflective | Surface layer 1*¹ | Thickness | | μm | — | 5 | 17 | 17 | 17 | 33 | |
| sheet | | Inert particle | Titanium dioxide | wt % | — | 10 | 10 | 10 | 10 | 10 | |
| | Medium layer | Thickness | | μm | — | 290 | 66 | 66 | 66 | 134 | |
| | | Inert particle | Calcium carbonate | wt % | — | 10 | 10 | 10 | 10 | 10 | |
| | | | Petroleum resin | wt % | — | 10 | 10 | 10 | 10 | 10 | |
| | Surface layer 2*¹ | Thickness | | μm | — | 5 | 17 | 17 | 17 | 33 | |
| | | Inert particle | | wt % | — | none | none | none | none | none | |
| | Entire layer | Thickness (tb) | | μm | — | 300 | 100 | 100 | 100 | 200 | |
| | | Reflecting | Total reflectance | % | — | 96 | 92 | 92 | 92 | 95 | |
| | | characteristics | Diffuse reflectance | % | — | 94 | 90 | 90 | 9 | 93 | |
| | | Total light | | % | — | 4 | 10 | 10 | 10 | 7 | |
| | | transmittance | | | | | | | | | |
| | | Degree of heat | MD | % | — | 1.6 | 1.7 | 1.7 | 1.7 | 1.6 | |
| | | shrinkage | TD | % | — | 0.4 | 0.4 | 0.4 | 0.4 | 0.4 | |
| | | (100° C.) | | | | | | | | | |

| | | | | | | | | | | |
|---|---|---|---|---|---|---|---|---|---|---|
| | Substrat layer (A) | | | | | | | | | |
| | Thickness (ta) | | μm | 300 | — | 100 | 400 | 800 | 600 | |
| | ta/tb | | | — | — | 1.0 | 4.0 | 8.0 | 3.0 | |
| | Inert particle | Titanium dioxide | wt % | 15 | — | 15 | 15 | 15 | 15 | |
| | | Talc | wt % | 10 | — | 10 | 10 | 10 | 10 | |
| | Reflecting characteristics | Total reflectance | % | 93 | — | 90 | 93 | 94 | 93 | |
| | | Diffuse reflectance | % | 92 | — | 88 | 92 | 92 | 92 | |
| | Total light transmittance | | % | 2.5 | — | 9.0 | 1.5 | 0.8 | 1.0 | |
| | Backing layer (C) | | | | | | | | | |
| | Same as void containing light | | | ◯ | — | ◯ | ◯ | ◯ | ◯ | |
| | reflective layer (B) | | | | | | | | | |
| | Biaxially stretched film (20 μm) | | | — | — | — | — | — | — | |
| | Aluminum evaporated flm (24 μm) | | | — | — | — | — | — | — | |
| Characteristics | 1) Thickness | | μm | 300 | 300 | 300 | 600 | 1000 | 1000 | 250 |
| | 2) Reflecting characteristics | Total reflectance | % | 93 | 96 | 97 | 97 | 98 | 98 | 98 |
| | | Diffuse reflectance | % | 92 | 94 | 94 | 95 | 96 | 96 | 95 |
| | 3) Total light transmittance | | % | 2.5 | 4.0 | 2.0 | 0.5 | 0.9 | 1.0 | 2.2 |
| | 4) Brightness | | cd | 402 | 439 | 437 | 437 | 436 | 438 | 440 |
| | 5) UV inducing yellowing | | | 0 | 0 | — | — | — | — | 32 |
| | resistance (b − b₀) | | | | | | | | | |
| | 6) Warping deformation | Before heat treatment | mm | 1.0 | 2.0 | 2.0 | 1.5 | 2.0 | 1.5 | 2.0 |
| | | After heat treatment | mm | 2.0 | 27.0 | 22.0 | 13 | 4.0 | 20.0 | 3.0 |
| | 7) Degree of heat shrinkage | MD | % | 0.2 | 1.6 | 1.4 | 1.0 | 0.7 | 1.2 | 0.6 |
| | (100° C.) | TD | % | 0.1 | 0.4 | 0.1 | 0.1 | 0.1 | 0.1 | 0.5 |

TABLE 3

| | | | | | Comparative |
|---|---|---|---|---|---|
| | | | | Example 12 | example 7 |
| Costitution of light | Void containing light reflective layer (B) | | | | |
| reflective sheet | Polyolefin resin | | | | |
| | Content of crystalline polypropylene (PP) | | wt % | 83.5 | 80 |
| | Content of propylene in crystalline polypropylene (PP) | | wt % | 100 | 100 |
| | Content of copolymer (RC) | | wt % | 16.5 | 20 |
| | Content of propylene in copolymer (RC) | | wt % | 64 | 50 |
| | MFR_{WHOLE} of polyolefin resin | | g/10 min | 2.8 | 9.4 |
| | MFR_{PP} of crystalline polypropylene (PP) | | g/10 min | 3.2 | 22 |
| | MFR ratio (MFR_{PP}/MRF_{RC}) | | | 2 | 75 |
| | Thickness (tb) | | μm | 30 | Stretching |
| | Reflecting characteristics | Total reflectance | % | 87 | impossible |
| | | Diffuse reflectance | % | 85 | |
| | Total light transmittance | | % | 20 | |
| | Degree of heat shrinkage (100° C.) | MD | % | 6.8 | |
| | | TD | % | 0.8 | |
| | Substrate layer (A) | | | | |
| | Thickness (ta) | | μm | 240 | — |
| | ta/tb | | | — | — |
| | Inert particle | Titanium dioxide | wt % | 15 | — |
| | | Talc | wt % | 10 | — |
| | Reflecting characteristics | Total reflectance | % | 93 | — |
| | | Diffuse reflectance | % | 92 | — |
| | Total light transmittance | | % | 2.5 | — |
| | Backing layer (C) | | | | |
| | Same as void containing reflective layer (B) | | | ◯ | — |
| | Biaxially stretched film (20 μm) | | | — | — |
| | Aluminum evaporated film (24 μm) | | | — | — |
| Characteristics | 1) Thickness | | μm | 300 | — |
| | 2) Reflecting characteristics | Total reflectance | % | 98 | — |
| | | Diffuse reflectance | % | 96 | — |
| | 3) Total light transmittance | | % | 1.7 | — |
| | 4) Brightness | | cd | 441 | — |
| | 5) UV inducing yellowing resistance | | | 0 | — |
| | (b − b₀) | | | | |
| | 6) Warping deformation | Before heat treatment | mm | 2.5 | — |
| | | After heat treatment | mm | 3.0 | — |
| | 7) Degree of heat shrinkage (100° C.) | MD | % | 0.5 | — |
| | | TD | % | 0.2 | — |

What is claimed is:

1. A light reflective sheet comprising a substrate layer (A), a void containing light reflective layer (B) on the light receiving side of the substrate layer (A), and a backing layer (C) on the non-light receiving side of the substrate layer (A), wherein the substrate layer (A) contains a layer made of a thermoplastic resin composition (a1) containing an inert particle of 5 to 40% in weight, and the void containing light reflective layer (B) is a uniaxially or biaxially stretched sheet made of a thermoplastic resin composition with a thickness (tb) of 10 to 90 μm and diffuse reflectance of 70 to 90%.

2. The light reflective sheet of claim 1, wherein the total reflectance of the substrate layer (A) is 70 to 98% and the total light transmittance of the substrate layer (A) is 10% or less.

3. The light reflective sheet of claim 1, wherein the ratio (ta/tb) of the thickness (ta) substrate layer (A) to the thickness (tb) of the void containing light reflective layer (B) is 4.5 to 40.

4. The light reflective sheet of claim 1, wherein the substrate layer (A) is composed of at least two layers, one layer thereof touching the void containing light reflective layer (B) is made of a thermoplastic resin composition (a1) containing an inert particle of 5 to 40% in weight, the thickness (ta1) is 30 to 1000 μm, at least one other layer is made of a thermoplastic resin composition (a2) containing no inert particle.

5. The light reflective sheet of claim 4, wherein the thermoplastic resins are the same kind of thermoplastic resin used for creating the thermoplastic resin composition (a1) and the thermoplastic resin composition (a2).

6. The light reflective sheet of claim 5, wherein the thermoplastic resins are a polypropylene resin for creating the thermoplastic resin composition (a1) and the thermoplastic resin composition (a2).

7. The light reflective sheet of claim 1, wherein the inert particle in the thermoplastic resin composition (a1) is titanium dioxide.

8. The light reflective sheet of claim 1, wherein the thickness (tb) of the void containing light reflective layer (B) is 15 to 60 μm.

9. The light reflective sheet of claim 1, wherein the thermoplastic resin composition of the void containing light reflective layer (B) contains an inert particle of 5 to 50% in weight, the inert particle is a thermoplastic resin composition (b1) containing a dicyclopentadiene petroleum resin with a softening point (ring ball method) of 160 to 200° C. and calcium carbonate with a mean particle diameter of 0.01 to 20 μm.

10. The light reflective sheet of claim 9, wherein the void containing light reflective layer (B) is constituted by lamination of a surface layer made of a thermoplastic resin composition (b3) containing titanium dioxide of 5 to 30% in weight on at least one side of a layer made of the thermoplastic resin composition (b1).

11. The light reflective sheet of claim 10, wherein the thermoplastic resins are the same kind of thermoplastic resin used for creating the thermoplastic resin composition (a1), the thermoplastic resin composition (b1) and the thermoplastic resin composition (b3).

12. The light reflective sheet of claim 11, wherein the thermoplastic resins are a polypropylene resin for creating the thermoplastic resin composition (a1), the thermoplastic resin composition (b1) and the thermoplastic resin composition (b3).

13. The light reflective sheet claim 1, wherein the thermoplastic resin composition forming the void containing light reflective layer (B) contains an inert particle of 5 to 60% in weight, the inert particle is a thermoplastic resin composition (b1′) containing a dicyclopentadiene petroleum resin with a softening point (ring ball method) of 160 to 200° C., calcium carbonate with a mean particle diameter of 0.01 to 20 μm and titanium oxide.

14. The light reflective sheet of claim 13, wherein the void containing light reflective layer (B) is constituted by lamination of a surface layer made of a thermoplastic resin composition (b3) containing titanium dioxide of 5 to 30% in weight on at least one side of a layer made of the thermoplastic resin composition (b1′).

15. The light reflective sheet of claim 1, wherein the thermoplastic resins are the same kind of thermoplastic resin used for creating the thermoplastic resin composition (a1), the thermoplastic resin composition (b1′), and the thermoplastic resin composition (b3).

16. The light reflective sheet of claim 15, wherein the thermoplastic resins are a polypropylene resin for creating the thermoplastic resin composition (a1), the thermoplastic resin composition (b1′), and the thermoplastic resin composition (b3).

17. The light reflective sheet of claim 1, wherein the thermoplastic resin composition forming the void containing light reflective layer (B) is a thermoplastic resin composition (b2) containing a polyolefin resin composed of crystalline polypropylene (PP) of 30 to 90% in weight and propylene-α-olefin copolymer (RC) of 10 to 70% in weight dispersed in the crystalline polypropylene, and the melt mass flow rate ratio MFR_{PP}/MFR_{RC} of melt mass flow rate MFR_{PP} of the crystalline polypropylene (PP) and melt mass flow rate MFR_{RC} of the propylene-α-olefin copolymer (RC) is 0.1 to 10.

18. The light reflective sheet of claim 17, wherein the thermoplastic resin composition forming the void containing light reflective layer (B) is a thermoplastic resin composition (b2′) further containing titanium dioxide of 5 to 30% in weight in the thermoplastic resin composition (b2).

19. The light reflective sheet of claim 18, wherein the void containing light reflective layer (B) is constituted by lamination of a surface layer made of the thermoplastic resin composition (b3) containing titanium dioxide of 5 to 30% in weight on at least one side of a layer made of the thermoplastic resin composition (b2) or (b2′).

20. The light reflective sheet of claim 1, wherein the substrate layer (A) and the void containing light reflective layer (B), are laminated by a extrusion laminating method.

21. The light reflective sheet of claim 1, wherein the backing layer (C) is at least of a type selected from the void containing light reflective layer (B), a thermoplastic resin sheet containing essentially no void and a metal evaporated sheet.
